(19) United States
(12) Patent Application Publication
(10) Pub. No.: US 2007/0131098 A1
(43) Pub. Date: Jun. 14, 2007

(54) Method to playback multiple musical instrument digital interface (MIDI) and audio sound files

(76) Inventor: Daniel William Moffatt, Edina, MN (US)

Correspondence Address: DANIEL W. MOFFATT, 6433 PARNELL AVENUE, EDINA, MN, 55435, US

(21) Appl. No.: 11/633,730

(22) Filed: Dec. 5, 2006

Related U.S. Application Data
(60) Provisional application No. 60/742,487, filed on Dec. 5, 2005.

(51) Int. Cl. G10H 7/00

(52) U.S. Cl. 84/645

(57) ABSTRACT

The present invention is method for the playback of multiple MIDI and audio files. More specifically, it is an interactive music playback method that enables real time synchronization, quantization, music and sound modification and management of playback resources. Further, the present invention provides a method of music performance using various sound files.

### CROSS-REFERENCE TO RELATED APPLICATION(S)

This application claims priority to U.S. Provisional Patent Application No. 60/742,487, filed Dec. 5, 2005, which is incorporated herein by reference in its entirety.

### TECHNICAL FIELD

The present invention relates generally to the field of music. More specifically, the present invention relates to music performance for live and studio music production.

### BACKGROUND OF THE INVENTION

In the past and present, music creation is produced by musicians performing on traditional and contemporary musical instruments. These performances, particularly pop and rock music is at times supplemented with “loops” or “sequences”; sound tracks that extend the musical content of the performance. In sound track enhanced performance, the musicians synchronize their performance with the active sound track assuming the sound track tempo and key. The combined content of live and pre-recorded music results in the complete musical output of the performance.

For example, a performer on tour has a financial budget that supports ten musicians. The music to be performed is orchestrated for a larger group. Loops/sound tracks are created to extend and enhance the live performance supplementing the performance of the touring musicians. The collection of sound tracks created are “static” and are not intended for real time modification in tempo or tonality during the live performance. Moreover, the playback of the sound track during live performance in many cases is controlled by a sound technician(s) and not the direct responsibility of the performing musician.

The format of these sound tracks are often audio files such as .mp3, .wav or other high quality sound file. Audio sound files contain data that represent the music in terms of the properties of the sound reproduction and is not a representation of the underlying composed music. Conversely, the MIDI (Musical Instrument Digital Interface) file format is a binary representation of note sequences, key signatures, time signatures, tempo settings and other metadata that comprise a complete musical composition. While the MIDI file contains information that determines the instrumentation and the duration of note values to be played by various instruments and other, it does not specify the actual sound output in terms of quality. It is simply a representation of the underlying music composition. A MIDI output device (a keyboard or audio player that supports MIDI or other device) is used to interpret the embedded MIDI messages in the file and provide the sound output referencing its sound library in accordance with the MIDI specification.

This use of sound tracks is intended to enhance and extend the performance of live musicians performing on conventional musical instruments. Since the sound tracks themselves are static or fixed, they are used for specific purposes within the performance and do not change. Sound tracks in the form of loops are not typically used or controlled by the performing musician using conventional performance instruments. Further they are not used for improvisation or spontaneous music invention. Hence, the application of this performance resource is currently limited to a supplemental or background performance role.

Consequently, there is a need in the art for a sound track player that enables musicians to control, modify and synchronize the playback of sound tracks in real time during performance. The sound track player would support real time improvisation, modification of the source sound track (or sound resource) and enable individual musicians real time interactive control and management of a library of sound resource for references during performance. The result of such a sound track player would enable the role of sound resources to elevate from supplementay background to essential and focal; assuming a dominant role in the performance.

### BRIEF SUMMARY OF THE INVENTION

The present invention, in one embodiment, is an interactive, real time file playback system for live and studio music performance. Unlike standard file playback technology consisting of one source sound file and one device for output, this playback system, or player, supports the simultaneous and real time synchronization of multiple MIDI and/or audio sources to one or more output devices. Individual clients communicate with the player host through the host command interface. The command interface receives commands from client entities and sets playback configuration parameters, stores and manages playback resources and performs real time performance operations. The player services these requests, manages and routes output to the appropriate output device(s).

In a further embodiment of the present invention, the playback system can be configured to assist people with physical or mental disabilities enabling them to participate with musicians of all skill levels.

While multiple embodiments are disclosed herein, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram of one embodiment of the functional components.

FIG. 2 is an activity diagram illustrating the flow of command processing in the embodiment of the present invention.

FIG. 3 is an activity diagram illustrating the activation of a playback resource.

FIG. 4 is an activity diagram illustrating the real time processing of an active playback resource(s).

### DETAILED DESCRIPTION

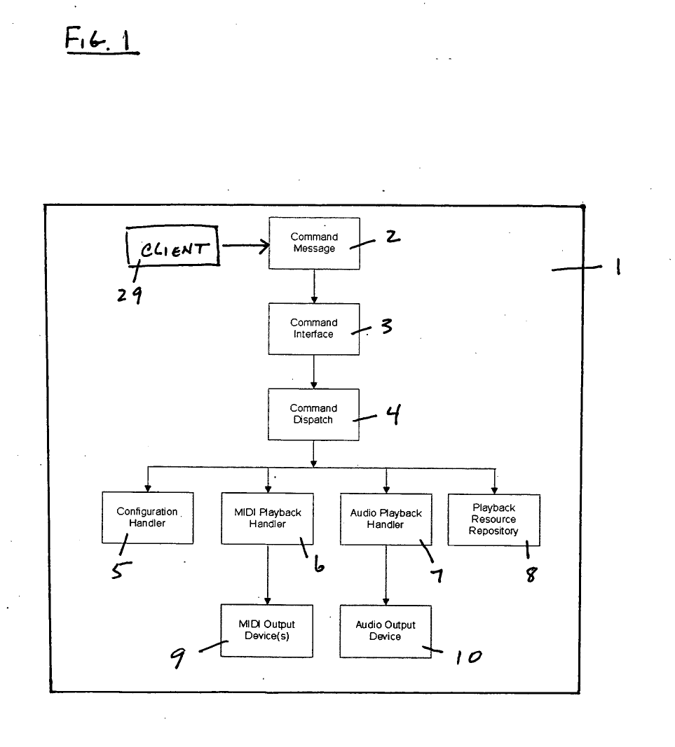

FIG. 1 shows a diagram outlining the functional components of the playback apparatus 1 of one embodiment of the present invention. As shown in FIG. 1, the playback apparatus 1 includes a command interface 3 that receives command messages 2 from a client 29. The client 29 may be a physical device, software object or any entity that can communicate command messages 2 with the command interface 3. The command interface 3 is responsible for parsing and validating the command message 2 and forwarding valid messages to the command dispatch 4. The command dispatch 4 examines the received command message 2 and routes the command message 2 to the appropriate command handler: configuration handler 5, MIDI playback handler 6, audio playback handler 7 or playback resource repository 8. All command handlers (5,6,7,8) are singleton object instances. Meaning, only one instance of each handler exists in the playback apparatus 1. MIDI playback handler 6 and audio playback handler 7 are responsible for sound output. Wherein MIDI playback handler 6 sends output to MIDI output device(s) 9 and audio playback handler 7 sends output to audio output device 10. In a further embodiment, multiple instances of playback handlers (6,7) may be implemented referencing a central metronome internal clock.

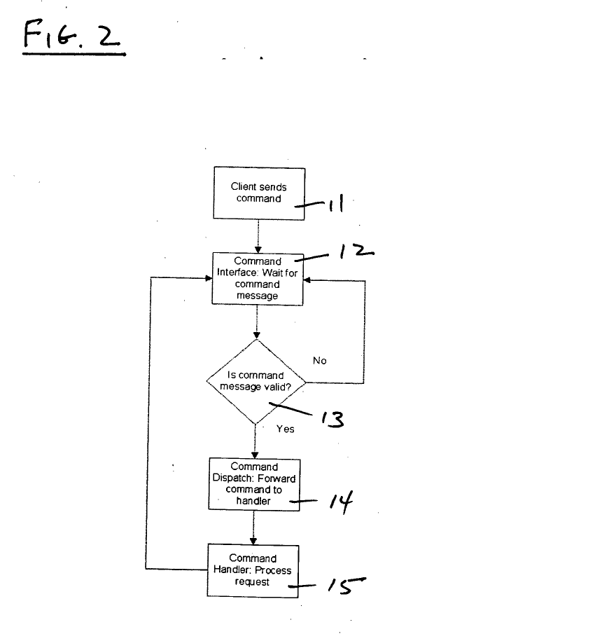

FIG. 2 is a flow diagram of command message handling in one embodiment of the present invention. As illustrated in FIG. 2, the client sends a command 11 to the command interface 3 where the command interface is in a wait state 12 for the receipt of a command message 2. Upon receipt of the client sent command message, the message is validated 13. If the command message 2 is not valid, the command interface 3 returns to wait state 12. If the received command message 2 is valid, the message is forwarded by the command dispatch 14 to a command handler 15 for processing.

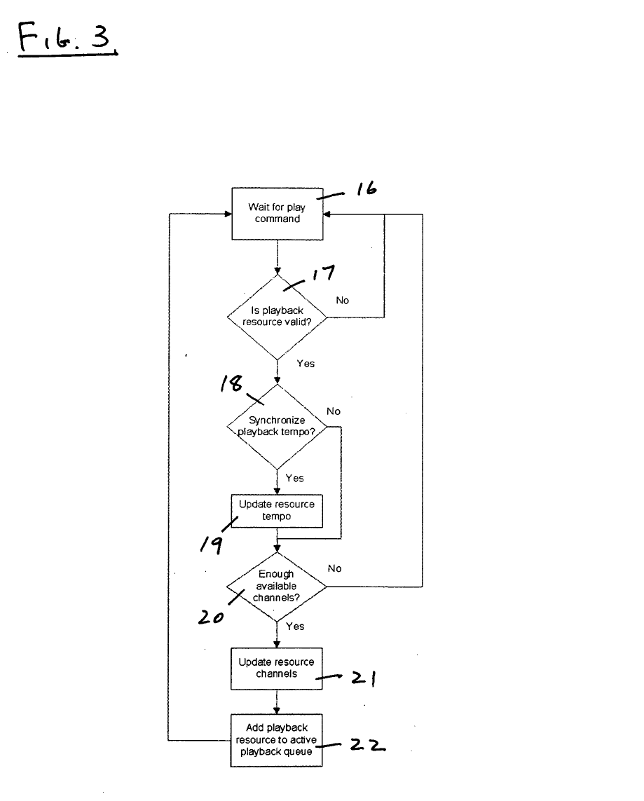

FIG. 3 is an activity diagram illustrating the process to activate a playback resource in playback apparatus 1 in one embodiment of the present invention. As illustrated in FIG. 3, the playback handler (6 or 7) remains in a wait state 16 until a command message 2 to play is received. The received play command message 2 contains a reference to a playback resource and playback attributes that provide playback parameters to the playback handler (6 or 7). The referenced playback resource is validated 17 with the playback resource repository 8. If the playback reference is invalid or disabled, the process returns to the wait state 16. If the playback reference is valid 17, the synchronize playback tempo attribute is examined. If the synchronize playback tempo 18 is set to true, the playback resource tempo is updated 19 to the internal playback metronome. If the synchronize playback tempo 18 is false, the playback resource tempo is not modified. The process then examines the playback channel requirement for the playback resource 20. If the playback handler (6 or 7) has adequate channels for playback 20, the playback resource channels are dynamically assigned and the playback resource channels are updated 21. The playback resource is activated and added to the playback queue 22.

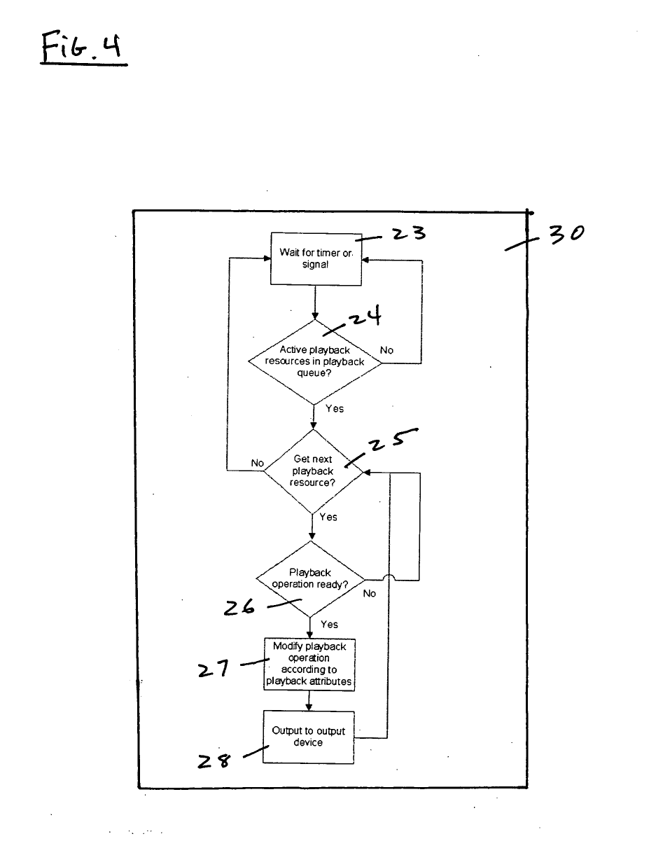

FIG. 4 is an activity diagram illustrating the processing of active playback resources in the playback queue. The playback process 30 waits for timer expiration or thread signal 23 to begin processing active playback resources. Upon signal the playback queue is examined for active playback resources 24 contained in the playback queue. If no resources exist in the playback queue, the process returns to the wait state 23. If one or more playback resources exist in the playback queue, the process traverses the playback queue 25 and process each playback resource. If a playback operation or output event is in the ready state 26, the playback resource and operation is modified according to the parameters contained in the playback attributes. These real time modifications to playback output events include playback quantization, key transposition, dynamic, expression and other musical or sound variations.

We claim:

1. An interactive, real time MIDI file and sound file processor comprising:
at least one client actuator configured to transmit processing commands;
a processing computer configured to provide physical and transport layer communication services for command and command response communication and provide output support for MIDI and audio files;
at least one MIDI output device;
an audio output device;
at least one speaker configured to receive the output signal and emit sound based on the MIDI or audio output signal;
a command interface configured to receive client configuration, MIDI and audio file processing commands;
a command dispatch processor that routes processing commands to the appropriate command handler;
a system configuration command handler that receives commands to processes runtime configuration parameters;
a MIDI file playback handler that receives commands to processes active MIDI files for sound output;
a audio file playback handler that receives commands to process active sound files for sound output;
a playback resource repository that manages and maintains MIDI and audio files referenced in the command messages and the MIDI and audio playback handlers;

2. The apparatus of claim 1 wherein the sound and the client action are interactive.

3. The apparatus of claim 1 wherein a client actuator may be a physical device, class object or any other entity capable of communicating to the command interface.

4. The apparatus of claim 3 wherein a client actuator sends processing commands to the command interface.

5. The apparatus of claim 4 wherein a client actuator receives processing command response messages.

6. The apparatus of claim 4 wherein the playback resource repository manages and persists sound resources such as MIDI and audio files.

7. The apparatus of claim 6 wherein sound resources (MIDI or audio file) may be added or removed from the playback resource repository via a command to the command interface.

8. The apparatus of claim 4 wherein the configuration settings received via the command message from client actuator are implemented at runtime and persisted for reference in future uses.

9. The apparatus of claim 8 wherein the configuration settings control the behavior of the command handlers.

10. The apparatus of claim 6 wherein playback resource repository publishes the names and all relevant data associated with the sound resources contained within the repository to client.

11. The apparatus of claim 4 wherein the client sends a play command referencing a playback resource in the playback resource repository to the command interface instructing the MIDI or audio playback handler to activate a playback resource for sound output.

12. The apparatus of claim 11 wherein the play command executed by the MIDI file playback handler or audio file playback handler, includes playback attributes that may modify the output of the original source sound file.

13. The apparatus of claim 12 wherein the play command attributes can modify the tempo, key, dynamics, transposition, expression, additional signal processing or any other modification that changes the musical content or sound output of the original source sound file.

14. The apparatus of claim 12 wherein play attributes further define looping, playback iteration count or other attributes of the playback resource that specify the time duration that the playback resource remains active.

15. The apparatus of claim 11 wherein the MIDI channels required for proper playback of a MIDI file playback resource are dynamically reassigned as needed by the MIDI file playback handler.

16. The apparatus of claim 1 wherein the MIDI file and audio file command handlers maintain a single internal metronome clock that determines playback tempo reference and enables playback resources to synchronize to a common tempo.

17. The apparatus of claim 16 wherein clients may subscribe to receive metronome clock notification indicating downbeat.

18. The apparatus of claim 16 wherein the tempo of the internal metronome clock may be changed at runtime by command message from client.

19. The apparatus of claim 11 wherein the play command adds a playback resource to the active playback queue list.

20. The apparatus of claim 12 wherein a playback quantization attribute indicates whether the playback resource is to begin at the next downbeat or to begin at the time of receipt of the command without regard to the internal metronome of the playback handler.

21. The apparatus of claim 20 wherein the playback quantization may assume a tolerance; an amount of time after the downbeat of the internal metronome downbeat that playback may begin.

22. The apparatus of claim 11 wherein the playback handlers provide callback notification messages to the client(s) that indicate measure beats, the completion of a playback resource or other information concerning resource playback.
